(19) United States
(12) Patent Application Publication
(10) Pub. No.: US 2018/0052830 A1
(43) Pub. Date: Feb. 22, 2018

(54) Unified Multilingual Communications Platform

(71) Applicant: AK Innovations, LLC, a Texas corporation, Plano, TX (US)

(72) Inventors: Azam Ali Mirza, Plano, TX (US); Claudia Mirza, Plano, TX (US); David Rhodes, Tempe, AZ (US); Edward Cavazos, JR., Elk Grove, CA (US)

(73) Assignee: AK Innovations, LLC, a Texas corporation, Plano, TX (US)

(21) Appl. No.: 15/679,818

(22) Filed: Aug. 17, 2017

Related U.S. Application Data
(63) Continuation of application No. 62/376,221, filed on Aug. 17, 2016.

(51) Int. Cl. G06F 17/28; G06N 5/02

(52) U.S. Cl. CPC G06F 17/289; G06N 5/02

(57) ABSTRACT

A multilingual communication platform for providing secure communication between a client and one or more linguists is disclosed. The platform performs the steps of determining, from a client, the type of desired linguistic service, determining if the type of desired linguistic service includes translation of a document, accessing a database of linguists to determine an appropriate linguist for the desired linguistic service, providing an electronic copy of the document to the linguist, if needed, connecting the client to the appropriate linguist via an audio communication link, if the desired linguistic service is an audio interpretation, connecting the client to the appropriate linguist via a video communication link, if the desired linguistic service is a video interpretation, and connecting the client to a scheduling database of available linguists, if the desired linguistic service is for an in-person interpretation. The platform may collect audio data, video data and documentary data for subsequent consumer analytics and insights.

### BACKGROUND

Linguistic services typically include translation services, involving written materials, and interpretation services, involving live or recorded audible materials. There are times when translation and/or interpretation services may be necessary or otherwise desirable for communicating between entities, such as people, corporate or otherwise. As used herein, the term linguistic services should be understood to include translations and/or interpretations between two spoken languages, between a spoken language and a physical language (such as sign language), between two written languages, or between entities having differing education/knowledge levels or skill-sets (i.e., between a lay person and a professional, such as a healthcare professional, a lawyer, an accountant, and engineer, or the like.

It may be desirable that linguistic services be secure so as to maintain confidentiality

It may also be desirable that linguistic services be provided on an on-line platform (herein collectively referred to as Platform).

It may be desirable that interpreters or translators (herein collectively referred to as linguists) provide the linguistic services.

It may be desirable that linguists are managed either by themselves or by an organization or company (herein collectively referred to as Linguistic Service Providers, or LSP's).

### DESCRIPTION OF THE FIGURES

For a more complete understanding of the disclosure, reference should be made to the following detailed description and accompanying drawings, wherein:

FIG. 1 is a flowchart illustrating operation of a unified multi-lingual communication platform (the Platform) in accordance with the present invention;

FIG. 2 is a block diagram illustrating a video remote interpreting tool of the Platform of FIG. 1;

FIG. 3 is a hierarchy diagram illustrating interaction of permission levels of users within the Platform which may be utilized in accordance with the present invention; and

FIG. 4 is a connection diagram illustrating interconnectivity of multiple service providers and multiple service requesters which may be utilized in accordance with the present invention; and

FIG. 5 is a connection diagram illustrating the buyer/seller relationship between different service Providers in accordance with the present invention.

### DESCRIPTION

While this invention is susceptible of embodiment in many different forms, there will be described herein in detail, a specific embodiment thereof with the understanding that the present disclosure is to be considered an exemplification of the principles of the invention and is not intended to limit the invention to the specific embodiment illustrated.

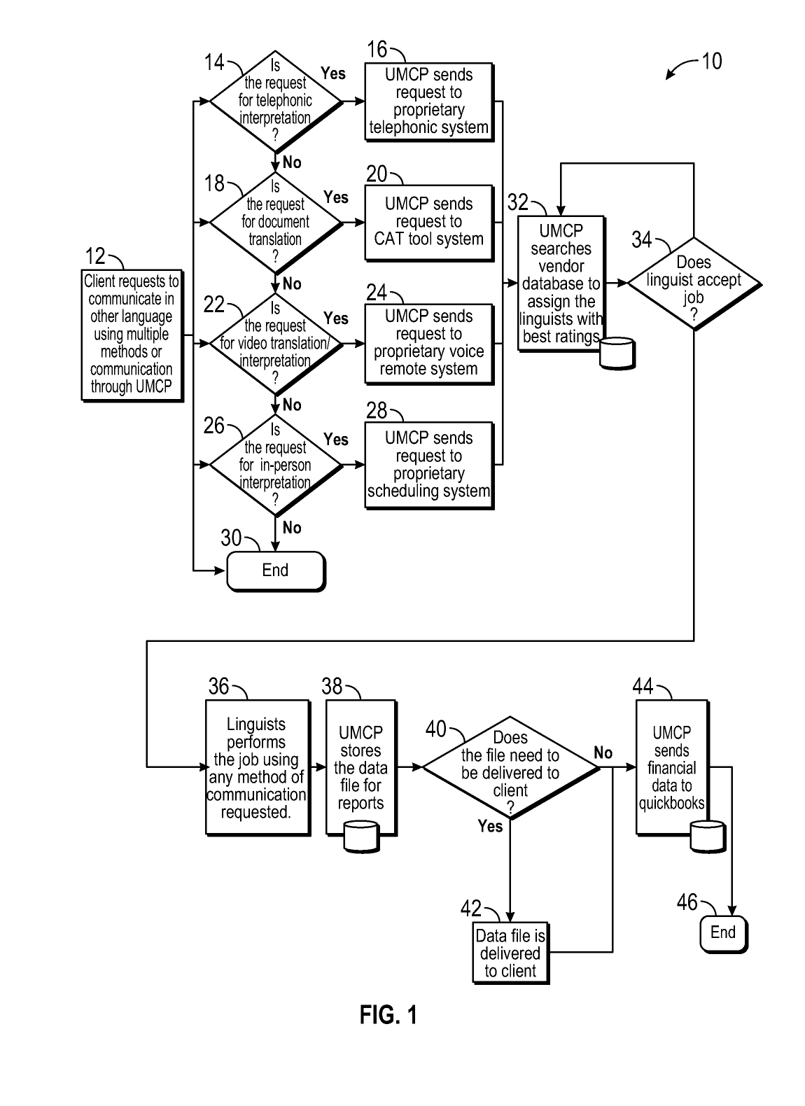

A unified multilingual communication Platform 10 for enabling language or other communication services is illustrated in FIG. 1. The Platform 10 language or other communication services may include translation, interpretation, education, or professional services for a variety of communication mediums, such as text, voice, video, in-person, or the like. The services may be provided through a single web and mobile-based platform driven by human talent in a secure way (e.g., in a manner to protect personal health information or “PHI”, credit card or PCI compliant).

The Platform 10 may provide a function to allow an entity/client (e.g., business or individual person) to place an order for a language or other communication service, such as an order for telephonic interpretation, a document translation, a video translation or interpretation, or an in-person translation or interpretation (e.g., in the business, telemedicine, education or other industries or applications).

The Platform 10 may further provide a function to allow a linguist or other provider to have access to and accept the order.

The Platform 10 may further provide, where applicable, a function to connect the client with the linguist/provider, such as through video, with additional functions such as to allow: (1) the linguist to request a team linguist for long or complex sessions; (2) limiting visibility between the client, linguist and the team linguist, such as the team linguist not being visible to the client at the request of the linguist and the team linguist and the linguist being visible to each other; and (3) the linguist to transfer the order to the team linguist or dismiss the team linguist.

The Platform 10 may still further provide, where applicable, having the order data enabled, such as the linguists collecting call-specific data on the client and logging the data in a secure database to be visible for search later by the linguists or client, such as using data analytics and feedback to the client.

The Platform 10 may still further provide uploading, translating, and proofing a document by the linguist in an efficient manner.

The Platform 10 may still further provide navigation tools to enable the client to monitor any linguist in transit to a specific requested location.

The Platform 10 may still further enable a matching between the client and the linguist based on a tier, rating, and/or cost structure.

The Platform 10 may provide language services for different mediums of communication (text, voice, video, person) through the same platform in a secure way.

The Platform 10 may be web and/or mobile based.

The Platform 10 may contain workflows to deliver professional machine and human translation, telephonic interpretation, on-demand and scheduled video remote interpretation and in-person interpretation in one single system.

The Platform 10 may provide customer-facing content that needs to be one hundred (100%) percent accurate.

The Platform 10 may allow entities, such as businesses, to place translation orders either from a mobile app or website. From there the Platform 10 may functionally integrate with linguists around the world, who may browse translation opportunities/jobs and begin translating right on their mobile device.

The Platform 10 may leverage machine translation (MT) only, machine translation with human post-editing, strictly human translation along with ancillary services that go with translation, like desk top publishing (DTP), voice over, or the like. While the Platform 10 may be free for linguists to sign up and begin searching for jobs, those linguists placing orders may or may not be required to pay per word, or otherwise, for translation services.

One embodiment of the Platform 10 in accordance with the present invention is illustrated in FIG. 1.

The Platform 10 may include a communication platform leveraging both Private Branch Exchange (PBX) and Session Border Controllers (SBC) technologies, to support SIP-VoiP and video connectivity. The Platform 10 may supports inbound connectivity via telephone, PC, iPad, and Android devices. Linguists may choose the end point they wish to use for services, including a proprietary soft phone, a landline, or a mobile phone. Linguists that receive calls via the Platform 10 may capture data within the browser window that are specified by clients.

In a first step 12, a client may request to communicate in another language using the Platform 10. In a decision step 14, the Platform 10 may determine if the request is for a telephonic interpretation. If yes, the Platform 10 may send a request to a telephone system, proprietary of otherwise, supported by the Platform 10, in a step 16.

If no, the Platform 10 may pass to a decision step 18 to determine if the request is for a document translation. If yes, the Platform 10, depending on the type of translation request (such as machine translation only, machine translation with post-editing, human translation, human translation with ancillary services, or the like) may send the translation request to a processing engine. Depending on the type of request, this processing engine may directly access a machine translator, or perform machine translation, and send to human linguists to post-edit or schedule a human translation team to work on the request.

If no, the Platform 10 may pass to a decision step 22, which determines if the request is for a video translation/interpretation. If yes, the Platform 10 may send a request to a video remote system supported by the Platform 10, which may be conventional or proprietary.

If no, the Platform 10 may pass to a decision step 26, which determines if the request is for an in person interpretation. If yes, the Platform 10 may send the request to a conventional scheduling system supported by the Platform 10. If no, the Platform 10 may ends its inquiry in a step 46.

Each of these steps 16, 20, 24, and 28 may then pass to a step 32 wherein the Platform 10 may search a database, supported by the Platform 10, of established and available translation vendors to determine a linguist having the best rating for the potential assignment, and sends a request to the determined vendor. The vendors included on the database may monitor the Platform 10 via their respective web- connected devices, such that the determined vendor may be notified and may respond. Once a vendor has accepted the assignment, the vendor, in a step 36, may perform the job using any method of communication requested, on-site, video, telephone, or the like. Once the job is performed, the Platform 10 may store the data file for the report in a step 38. If telephonic of video translation, the Platform 10 may store a log file of the work performed and/or an actual recording of the telephonic/video translation.

The Platform 10 may then pass to a decision 40 to determine whether the file needs to be delivered to the client. If yes, a data file may be delivered to the client in a step 42, and the Platform 10 may send financial data relating to the transaction to a conventional financial/accounting software package, such as QuickBooks, which may perform conventional accounting and billing functions. If no file need to be delivered to the client (step 40), the Platform may still send financial data relating to the transaction to the financial software package. At this point, the process may be completed in a step 46.

In certain situations, a document, such as a form, may require translation, such as during a doctor visit, when an linguist is already on video. The linguist may read the form to the patient, in a manner understandable to the patient, and the linguist may help the patient complete the form. The linguist may read the document to the patient, for example if the patient has limited English language proficiency, and the patient may acknowledge he/she understands the document, and the Platform 10 may record the call, including the patient's acknowledgement, at that moment for later use.

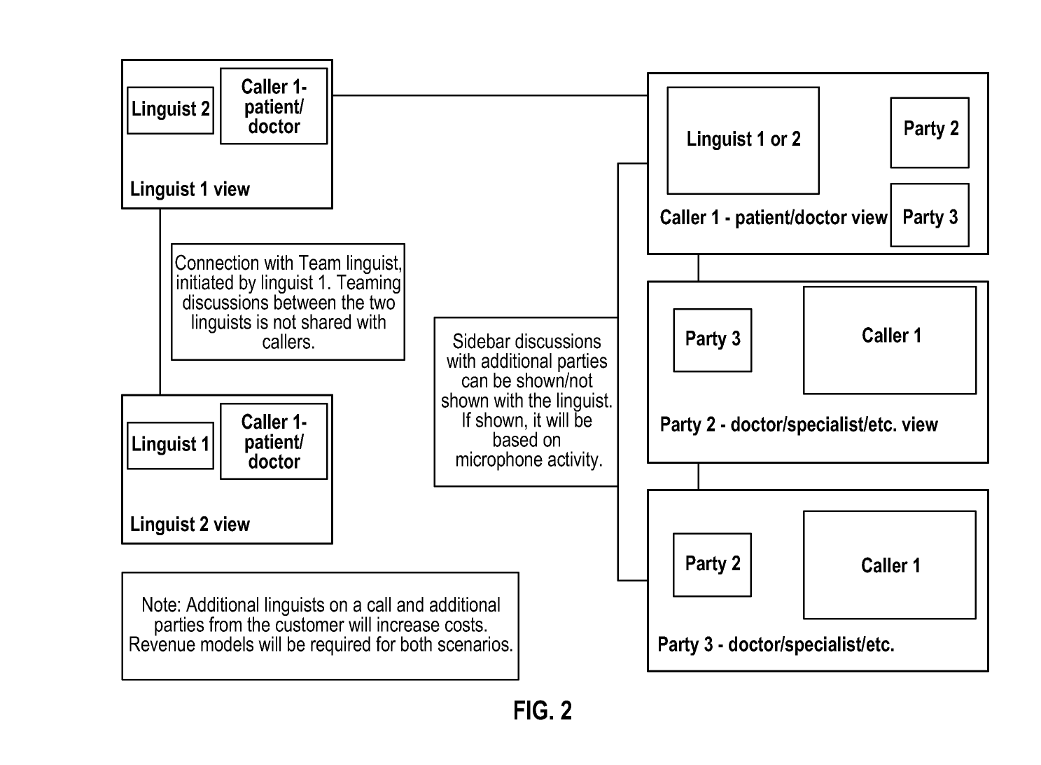

Referring to FIG. 2, a block diagram illustrating a video remote interpreting tool, which may be supported on the Platform 10 and which may be utilized in accordance with the present invention, is illustrated.

The tool may be utilized to permit various parties, having various responsibilities and needs, to participate in video communication.

In the example illustrated in FIG. 2, assume the “caller” is a primarily English-speaking doctor consulting with a primarily non-English speaking patient (herein, an ESL patient). Assume the doctor needs to consult with, for example, two (or more) other consulting doctors (or other healthcare providers).

Referring to FIG. 2, box 50 illustrates a screen view as seen by the doctor and patient when connected to the Platform 10. Box 52 illustrates a screen view as seen by a first linguist when connected to the Platform 10. Box 54 illustrates a screen view as seen by a second linguist when connected to the Platform 10. Box 56 illustrates a screen view as seen by a first consulting doctor when connected to the Platform 10. Box 58 illustrates a screen view as seen by a second consulting doctor when connected to the Platform 10.

As shown in FIG. 2, the doctor/ESL patient may view, in real time, either the first or second linguist, depending on which linguist is selected to be active at the time, as well as the each of the consulting doctors. Each of the consulting doctors may see the doctor/ESL patient as well as the other consulting doctor. Each of the linguists may see the other linguist, as well as the doctor/ESL patient.

The linguists may alternate providing interpretation services, such that each linguist may stay current with the conversation, even when not providing the interpretation service. The linguists may speak with each other, and their conversation may be blocked (i.e., not shared) with the doctor/ESL patient.

As noted above, the video remote interpreting tool illustrated in FIG. 2 may also be applicable to other situations involving multiple parties requiring real time video interpretation, such as clients with lawyers, accountants, engineers, or the like.

The Platform 10 may allow multiple users from different organizations to conduct and transact business.

The Platform 10 may permit different organizations, such as Linguistic Service Providers (LSP's) to use their own branding, logos, names, titles, or other markings (i.e., white labeling)

The Platform 10 may permit white labeling LSP's to have an automatic subdomain created for its clients (ex: https://whitelabel.theumcp.com), which may display the white label LSP's logo. The Platform 10 may offer a tool that allows white label LSP's to change the specific subdomain to one that is more desirable.

Database and underlying architecture of the Platform 10 may be structured so as to permit multiple users with varying levels of permissions to interact with information captured and stored on the Platform 10.

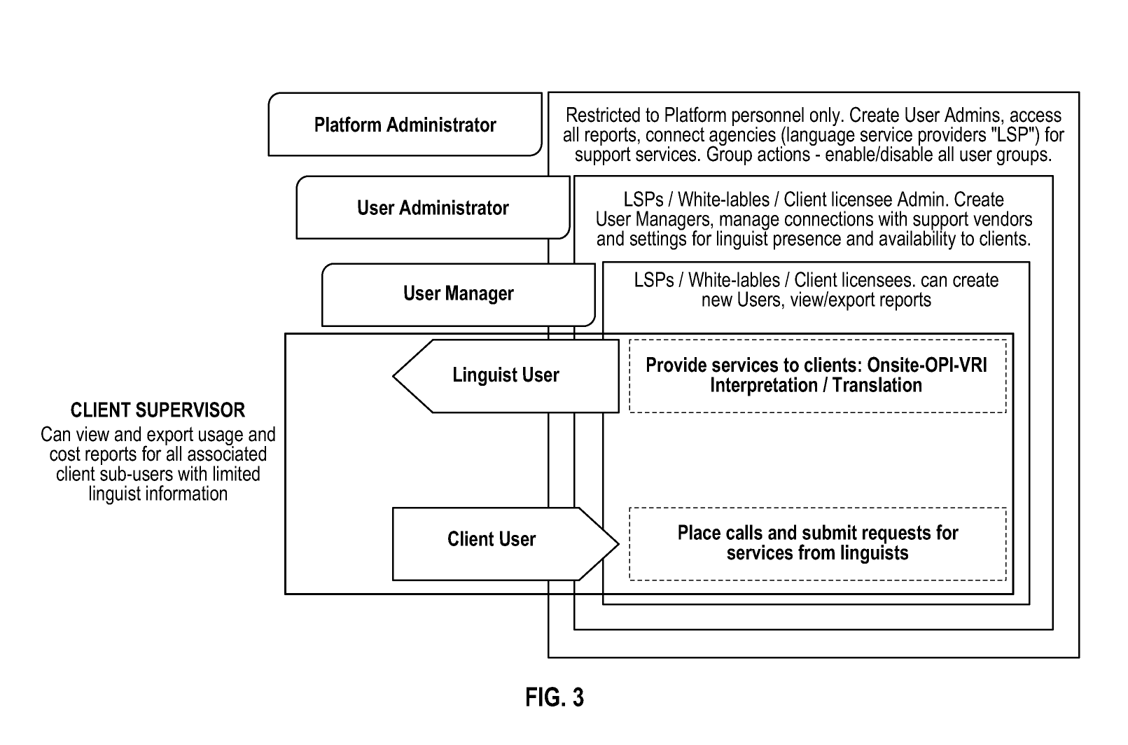

Various user roles are illustrated in FIG. 3. The user roles may include: Platform, or UMCP, Administrator (Platform Admin), User Administrator (User Admin), User Manager (User Manager), and the like, each having different permission levels.

Platform Admins may have access to the Platform 10 in order to administer other providers.

Other providers may purchase services without using the full branding functionality.

User Admins, User Managers and Client Supervisors may view all usage data associated with clients and linguists under the direct management of same.

User Admins, User Managers and Client Supervisors may not view any information related to another white label LSP's clients, except call data for services provided to the client directly.

An la carte option in the user interface (UI) of the Platform 10 may allow selection and delivery of specific linguistic services based on the requirements of the particular white-label LSP. A la carte settings may be set by the Platform Admin.

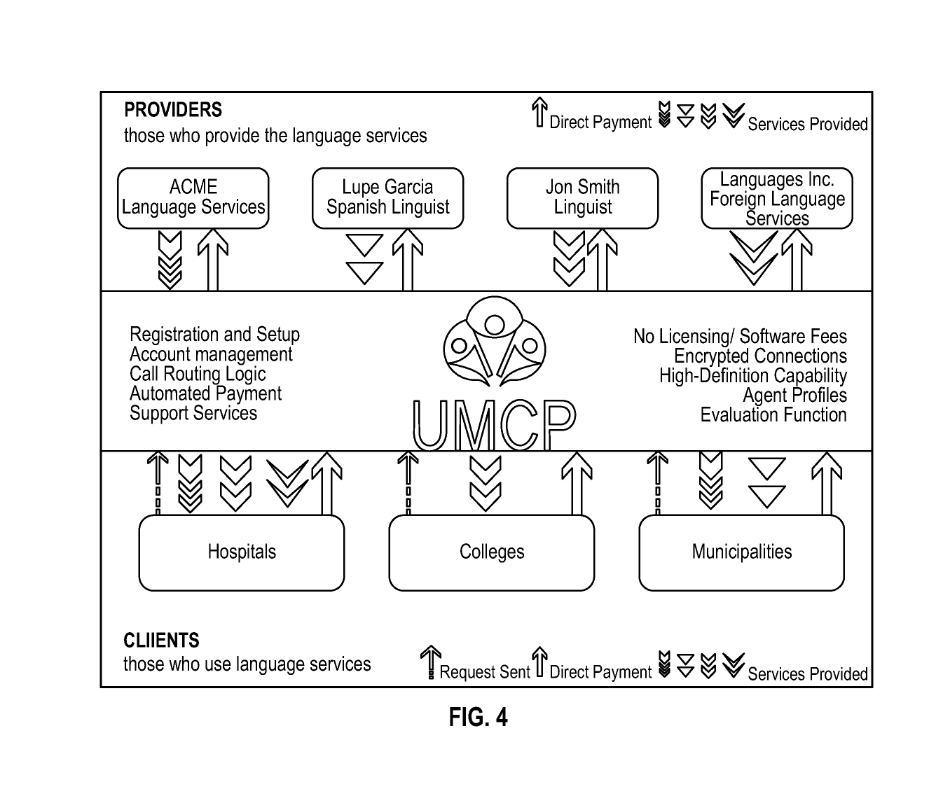

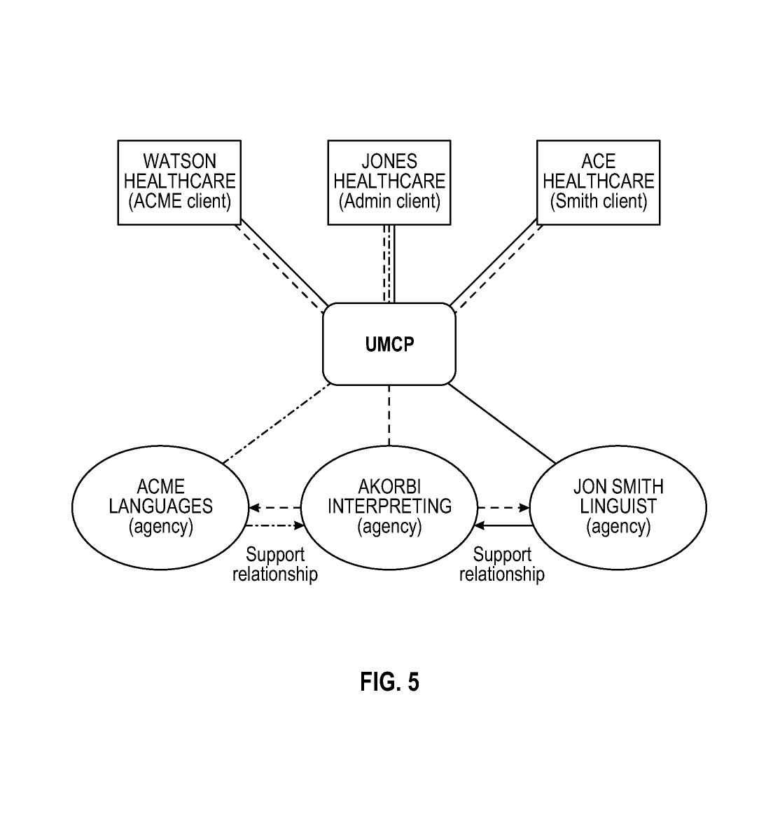

A la carte options may include:
a) LSP white-labeling of: OPI (over phone interpretation)/VRI (video remote interpretation)/Translation/Scheduling;
b) Cost, Pricing and Revenue tools for services offered to a white label LSP for easy tabulation and reporting;
c) Opt-in option of a white label LSP to receive support services from another LSP, as shown in FIG. 4 and FIG. 5; and
d) Opt-in option to connect LSP's together to allow linguist sharing.

Opt-in choices may include:
a) Ability to select LSP, by language, and by language-skill;
b) Price fields for linguists to include “wholesale” rates to be referenced when the Platform calculates costs for services sold to other Providers (VRI and OPI);
c) Architecture and logic so service requests from an LSP's own clients are first routed to the same LSP's, before being routed to the linguists of a support LSP.
d) This should function on a per-language/skill basis. For example, if LSP A has coverage for Spanish-Medical, but not Spanish-Mental Health. If the client of LSP A searches for Spanish-Mental Health, this client will be routed to the appropriate LSP support vendor.
e) The ability to “blacklist” a specific linguist from a specific LSP Provider or a specific client.

Linguist Rating: The Platform 10 may permit clients of a particular LSP to provide feedback on a particular linguist through the Platform 10. This feedback may be reflected in a rating, which may be visible to the User Admin and User Managers of the particular LSP.

Optionally, LSP A (or the Platform Admin) may offer an opt-in option to permit LSP providers B, C, etc., that are buying support services from LSP A, to see the ratings, left by any and all clients, for linguists that LSP's B, C, etc., are selling.

Provider Rating: When LSP A buys support services from LSP B, LSP A may have an option to assign a rating to LSP B, and LSP B may have an option to assign a rating to LSP A.

Ratings: If a rating system is used, and a better rating is received, the Platform 10 may permit a more highly rated LSP to receive rollover calls before the LSP with the lower rating.

Support—Hours of Coverage: The Platform 10 may permit LSP A to schedule coverage and rollover services. This on/off scheduling logic may allow a white-label LSP to pause coverage or set hours of coverage from support provider. Note: multiple agencies may be used as support vendors or not. It is the purchasing LSP's choice.

The Platform 10 may transcribe all calls. The Platform 10 may align both source and target languages to form a translation memory (TM) by context. This speech to text and alignment of source and target languages is data rich. This machine transcription (MT) may be followed by human clean up if needed. This collected data can now be used for:
a) Machine learning about non-Eng (non source language) members (callers);
b) Use artificial intelligence (AI) to determine patterns in calls and caller needs;
c) This topic specific TM created may feed that language-subject specific MT tools to provide better output for translations. So, time to market for translations has decreased.
d) This TM created can now be used to build a foreign language Avatar that can now decrease the need for linguists as it can handle a LSP member through many of similar questions

It is to be understood that this disclosure is not intended to limit the invention to any particular form described, but to the contrary, the invention is intended to include all modifications, alternatives and equivalents falling within the spirit and scope of the invention as defined by the appended claims.

1. For a client desiring one of a plurality of types of linguistic services, a multilingual communication platform for connecting the client with a linguist, the platform performing the steps of:
determining, from the client, the type of desired linguistic service;
determining if the type of desired linguistic service includes translation of a document;
accessing a database of linguists to determine an appropriate linguist for the desired linguistic service;
providing an electronic copy of the document to the linguist, if needed;
connecting the client to the appropriate linguist via an audio communication link, if the desired linguistic service is an audio interpretation;
connecting the client to the appropriate linguist via a video communication link, if the desired linguistic service is a video interpretation; and
connecting the client to a scheduling database of available linguists, if the desired linguistic service is for an in-person interpretation.

2. The platform of claim 1, including storing a log file of the linguistic service provided.

3. The platform of claim 1, including storing a recoding of the linguistic service provided.

4. The platform of claim 3, wherein the stored recording is utilized to create a translation memory for future linguistic services.

5. The platform of claim 4 including providing a machine translation for the desired linguistic service.

6. The platform of claim 1 operable for a plurality of linguistic service providers (LSP's).

7. The platform of claim 6, including the step of permitting the LSP's to white label their respective presence on the platform.

8. The platform of claim 1 wherein the steps are provided through a web and mobile-based platform.

9. The platform of claim 1 including the step of connecting the client to a plurality of linguists.

10. The platform of claim 1 including the step of permitting editing of the electronic copy of the document.

11. The platform of claim 1 including utilizing artificial intelligence to determine patterns in the linguistic service provided.
